(19) United States
(12) Patent Application Publication
(10) Pub. No.: US 2007/0218564 A1
(43) Pub. Date: Sep. 20, 2007

(54) Use of a Composite or Composition of Diamond and Other Material for Analysis of Analytes

(75) Inventors: Peter Klaus Bachmann, Wuerselen (DE); Volker Van Elsbergen, Aachen (DE); Ralf Hoffmann, Eindhoven (DE); Helga Hummel, Aachen (DE); Carolina Maria Ribbing, Aachen (DE); Detlef Uwe Wiechert, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC N.V., EINDHOVEN (NL)

(21) Appl. No.: 11/568,191

(22) PCT Filed: Apr. 13, 2005
(86) PCT No.: PCT/IB05/51212

§ 371 Date: Oct. 23, 2006

(30) Foreign Application Priority Data
Apr. 27, 2004 (EP) 04101761.7

(51) Int. Cl. G01N 1/00

(52) U.S. Cl. 436/174

(57) ABSTRACT

The present invention relates to the use of composites or compositions of diamond/non-diamond material, e.g. diamond/non-diamond carbon material for chemical or biological analysis. The invention further relates to the use of this material in separation adherence and detection of chemical of biological samples. Applications of either structurized substrates or mixed phase particles of this material include but are not limited to processes which involve desorption-ionization of a sample, more specifically mass spectroscopy.

The present invention is directed to compositions for use as substrate and/or matrix material in desorption-ionization analytics as well as methods of making the same and apparatus for desorption-ionization analytics using the compositions.

Mass spectrometry (MS) is used to measure the mass of a sample molecule, as well as the mass of the fragments of a sample to identify that sample. It has become an indispensable tool for the analysis of biological molecules such as proteins and peptides, and the widespread use of MS is a reflection of its ability to solve structural problems not readily or conclusively determined by conventional techniques.

Basically, MS analysis comprises the degradation of a sample into molecules which are converted to gas-phase ions by an ionizer, separation of these ions in a mass analyzer and detection by an electron multiplier. The result is a spectrum, which represents the ratio of the mass of the molecules to the corresponding ion's electric charge.

The most commonly used analyzers are either based on acceleration of the ions into a magnetic field or time-of-flight (TOF). TOF accelerates the sample ion with a known voltage, and measures how long it takes an ion to travel a known distance. Alternatively, a selection of molecules within a specific range mass can be obtained by passing the ions through magnetic poles of which the polarities are rapidly alternated.

Time-of-flight analysis can further be improved by the provision of a reflectron or ion mirror, which has an applied voltage, which is slightly higher than the accelerating voltage at the source, so that the ions are subjected to a repelling electrical field. This improves the resolution of the detection.

Ionization of the samples can either be performed by electrospray ionization (ESI) or by desorption ionization, the latter allowing analysis of molecules that are not easily rendered gaseous by starting from a sample adsorbed on a substrate. The technique of direct desorption ionization has not been extensively used, because rapid molecular degradation and fragmentation are usually observed upon direct exposure of the molecules to laser radiation. An important improvement in desorption mass spectrometry was the introduction of an organic matter as a vehicle for desorbing and ionizing the sample, a technique now also referred to as matrix-assisted laser desorption/ionization (MALDI). The matrix is added in large excess to the sample material and is believed to act as both an efficient proton absorber and energy transmitter to the molecules. As UV lasers are common in MALDI-MS, matrix molecules that absorb UV light are required (dihydrobenzoic acid or trans-cinnamic acid are very common).

MALDI, though very widely used is limited by the signal noise introduced by the matrix itself. In the MALDI approach, the molecular solution to be analyzed is mixed into an organic resin, which is placed on a sample plate and allowed to solidify. The sample plate, which can hold a number of samples, is loaded into a vacuum chamber where the “time of flight” analysis is performed. An organic matrix on a substrate holds the molecular species to be detected while acting as an energy absorber. A laser then impinges on the matrix-analyte mixture, and, when the matrix absorbs the laser energy, it vaporizes. The resulting desorbed molecules, which include the analyte and matrix components, are then mass analyzed. Matrix material molecules add to the collected signal, however, preventing the detection of smaller molecules. The inclusion of the matrix molecules into the collected signal limits the low mass detection of this method to above 500 amu, but it has proven to be effective for analyzing a large range of molecules up to approximately 100,000 amu. Thus, for analysis of low mass analytes (<m/z 500), irreproducible and heterogeneous co-crystallization, suppression of ionization by electrolytes and other additives, and interference from matrix ions have limited the utility of MALDI in automated high-throughput combinatorial and chip-array analyses. Besides low mass and noise limitations, further downfalls of this system lie in the sample preparation itself, because the matrix/sample mixture requires experienced chemical handling, usually requires time-consuming drying, and has throughput limitations for large scale clinical applications. The use of matrix material often requires additional washing steps and chemical compatibility of the matrix, solvent and sample. Finally, for each laser wavelength (e.g. visible or IR), an adapted matrix has to be used.

A variation of this technology is referred to as SELDI (surface enhanced laser desorption/ionization) or SALDI (surface assisted laser desorption/ionization) MS, involves the interaction of samples with surfaces prior to and during vaporization for MS. The surfaces are modified in such a way that interaction with the (bio) analyte results in a selective retention (or release) of material, similar to a cleaning process. This ultimately leads to improved MS spectra, i.e. better S/N ratios, lower background and/or allowing a more conclusive identification of the MS-peaks or peak patterns. Desorption ionization has been achieved from electrochemically etched conventional porous silicon. (Thomas J. et al. 2001, Proc. Natl. Acad. Sci. 98(9):4932-4937). US2002/0048531 also describes the use of a porous light-absorbing semiconductor substrate such as silicon, more particularly vapor-deposited films for desorption ionization in visible DIOS-MS. However, surface chemistries of porous silicon surfaces are not favorable for specific functionalization (no carbon chemistry) and silicon surfaces are regularly oxidized resulting in contact resistance. Junghwan et al. (2002) describe the potential advantage of using of a graphite plate as a photon-absorbing material in combination with glycerol as a proton source in SALDI-MS.

It is known that diamond can be grown in polycrystalline form by various chemical vapor deposition (CVD) processes, including but not limited to plasma CVD processes. The phase purity, which depends on the growth conditions can be determined by means of Raman spectrometry. CVD diamond can be grown as homo- and hetero-epitaxially single crystals and in polycrystalline form with the size of individual crystallites and crystal domains depending on the deposition conditions, the substrate used and the substrate surface preparation applied prior to the deposition process. Deposition can be done on different substrates, depending on the application, including glass, and silicon. Wang et al. (2000, J. Phys. Conds. Matter 12(13):L257-260) describe the deposition of a CVD diamond film on porous silicon. Non-diamond carbon phases are often found at the grain boundaries of polycrystalline diamond films. These can be removed by oxidizing agents. During CVD diamond growth it is possible to add compounds to the CVD gas phase that are co-deposited with the growing diamond material and act as a dopant, i.e. they change the electronic properties of CVD from insulating to n- or p-type semiconducting and shift the absorption to longer wavelengths.

The surface of diamond, including CVD diamond can be chemically modified, e.g. by hydrogen- or oxygen-terminating all or part of the surface, so as to selectively bind DNA or other biopolymers to the surface, which can then be used e.g. for performing a variety of chemical reactions. Additionally, CVD diamond can be etched by oxygen to obtain a porous (and as indicated above more phase-pure) diamond structure (Bachmann et al., 1993, Diamond and related matters 2:683).

The present invention relates to the use of a composite or composition of diamond and other material in methods for detection of analytes in a sample. More particularly the present invention relates to a composite or composition of diamond and another material, more particularly a conductive material, e.g. non-diamond forms of carbon, which are advantageous for use in detection methods of analytes which involve desorption-ionization. The materials of the present invention are advantageous for use in detection methods which involve use of energy, e.g. the discharging of laser energy, on the sample, thereby transforming the analytes in the sample into charged particles, which are subsequently detected by a detector. More particularly, the materials of the present invention provide specific advantages for use in Mass spectrometry (MS) analysis. More specifically the material of the present invention can be used as a substrate or as a mixture of particles in MALDI-like analysis

Thus, according to a first aspect of the invention a composition or composite of diamond/non-diamond, e.g. carbon, (hereafter referred to as diamond/non diamond composite material or D/NDC) is used in a method for detection of analytes in a sample.

A particular embodiment of the present invention relates to the use of a composition or composite of diamond/non-diamond, material as a substrate in desorption/ionization analytics. More particularly, the material of the invention is suitable as a substrate in mass spectrometry analysis.

According to the present invention, the non-diamond component of the composite or composition of diamond/non-diamond material is conductive and renders said diamond/non-diamond material composite or composition conductive. This has the important advantage that it can be electrically contacted through the supporting structure in order to apply constant, alternating or pulsed electrical potentials to the analytes captured, immobilized or absorbed on the surface of the material of the invention. According to a particular embodiment of the present invention, the non-diamond component of the composite or composition is any form of non-diamond carbon.

Optionally, according to the present invention, the diamond/non-diamond, e.g. carbon, composite substrate or substrate surface is modified or functionalized in a physical and/or chemical way so as to improve substrate characteristics and/or so as to allow selective adherence and/or release of analytes in a sample. Physical modifications can include the three-dimensional structures including cauliflower or needle-like structures and/or making the material porous. Thus, a particular embodiment of the present invention relates to the use in desorption/ionization analytics of diamond composite material having a three-dimensional (surface) structure. A further embodiment of the present invention relates to the use of porous diamond carbon composite films in desorption/ionization analytics.

Chemical functionalization can be achieved by any suitable molecules, e.g. including reactive, non-reactive, organic, organo-metallic and non-organic species. More particularly, chemical modification can comprise steps such as oxidation, reduction, addition of chemical groups.

One particular advantage of the material of the present invention is not only that it absorbs efficiently over a wide wavelength range but that the absorption can be tuned to adapt its performance to the energy source, e.g. the light source used in the excitation/irradiation/desorption step. Thus, according to an aspect of the present invention, the step of exciting, e.g. irradiating the analyte-loaded substrate can be performed using a light source of a wavelength between 100 nm and 1000 μm, i.e. including ultraviolet, visible or infrared light. Thus, additionally or alternatively according to the present invention, the composition of the diamond carbon composite is adapted to ensure adsorption at a specific wavelength corresponding to the wavelength of the light source used for desorption/ionization of the sample.

Thus, one aspect of this invention contemplates a method for providing an analyte ion suitable for analysis of a physical property. That method comprises the following steps:
a) providing a substrate comprising a composition or composite of diamond/non-diamond material;
b) providing a quantity of a sample comprising an analyte having a physical property to be determined the diamond/non diamond material substrate; and
   c) irradiating the analyte-loaded substrate to provide an ionized analyte.

Once ionized under reduced pressure, the analyte ion is suitable for analysis to determine a desired physical. Analyzing the analyte comprises one or more physical methods of analysis that illustratively include mass spectrometry, electromagnetic spectroscopy, chromatography, and other methods of physical analysis known to skilled workers.

Accordingly, in accordance with a particular embodiment of this invention, a method for determining a physical property of an analyte ion is contemplated. That method comprises the following steps:
a) providing a substrate comprising a composition or composite of diamond/non-diamond material;
b) providing a quantity of sample comprising an analyte having a physical property to be analyzed to the diamond/non diamond material substrate;
c) irradiating the analyte-loaded substrate to provide an ionized analyte; and
d) analyzing the ionized analyte for the physical property.

In a particular embodiment, the determined physical property is mass, and an above contemplated method for determining a physical property of an analyte ion analyzes the mass to charge ratio (m/z) of the analyte ion by mass spectrometry techniques.

Thus, the present invention relates to improved methods and apparatuses for mass spectrum analysis of samples.

More specifically, the present invention relates to the use of a composition or composite of diamond/non-diamond carbon material for the determination of a physical property of an analyte.

As a new desorption/ionization approach, the present invention offers excellent sensitivity, high tolerance of contaminants, and does not require the use of a matrix. Alternatively, the material of the present invention can be used in the form of particles as a matrix in MALDI-like analysis. Moreover, because the surface properties of the diamond/non diamond composite material or composition, more particularly those of the diamond/non diamond carbon composite material or composition can be easily tailored, the present invention can provide improved analysis for biomolecular mass spectrometry applications. This is of particular relevance for the analysis of biological samples including human, animal and plant samples such as the analysis of samples of tissue, blood or other fluids. Thus the present invention provides methods of analysis with improved resolution for use e.g. in diagnostics.

According to another aspect the present invention relates to an apparatus for providing an ionized analyte for analysis. The apparatus can be provided with one or more substrates, which is a substrate comprising a composite or composition of diamond/non-diamond or a substrate coated with the composite or composition of the diamond/non-diamond material, more particularly the diamond/non-diamond carbon of the present invention. The apparatus also has a source of energy, e.g. of radiation of which light energy is only one example. When the source of radiation irradiates the substrate of the invention on which the analyte is adsorbed, irradiation will cause desorption and ionization of the analyte for analysis.

According to another aspect the present invention relates to substrates specifically adapted for use in an apparatus which provides an ionized analyte for analysis, more specifically a substrate which comprises a composite or composition of diamond/non diamond material or which is coated with a composite or composition of diamond/non diamond material. A particular embodiment of the present invention relates to substrates which comprise a composite or compositions of diamond/non-diamond carbon material or which are coated with a composite or composition of diamond/noon-diamond carbon material. Based on their physical and/or chemical properties, the substrates of the present invention allow improved analysis of the ionized analyte.

According to another aspect the present invention relates to Mass spectrometric patterns generated using the diamond carbon composite material of the present invention. Such patterns may be characterized by the presence of characteristic diamond/non-diamond material peaks (when the material of the invention is used as a conventional matrix) or can be characterized by a specific profile due to the interaction between analyte and the diamond/non-diamond composite or composition substrate material of the invention. A further aspect of this invention thus relates to a data structure comprising the patterns obtained using the substrates of the present invention stored in a memory device, e.g. a diskette, a solid state storage device such as a memory of a computer or a memory of a network device, an optical storage device such as a CD-ROM or a DVD-ROM, or a tape storage device.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The present invention relates to a composite or composition of diamond/non-diamond, e.g. carbon material also referred to as D/NDC material and its use in methods and apparatuses for analysis of bioanalytes.

‘A composite or composition of diamond/non-diamond material’ according to the present invention is material which is not composed of phase pure diamond but contains a non-diamond component. The non-diamond component is a conductive material. According to a particular embodiment of the invention this non-diamond component is a non-diamond carbon component. Typically, the diamond/non-diamond carbon material is obtained by chemical vapor deposition and encompasses grain boundaries decorated with defects and non-diamond carbon phases (also referred to as ‘mixed phase’), as evidenced by Raman spectroscopy. More particularly, the Raman spectrum of the material of the present invention is characterized by a “diamond” peak (at 1332+/−15 cm⁻¹) and one or more additional Raman bands. For very small diamond grain sizes a peak at around 1150+/−50 cm⁻¹ is also indicative of the presence of diamond in the composition or composite material. With regard to the additional Raman bands, where non-diamond material is carbon, the Raman spectrum of the diamond/non-diamond composite material or composition displays, in addition to the diamond peak, characteristic “G” (graphitic) and/or “D” (disorder) peaks which are both broadened, with the former present as a wide band at ˜1530 to 1600 cm⁻¹ and the latter at ˜1140 to 1300 cm⁻¹ (which can appear to underlie the diamond peak).

Thus, according to a particular embodiment of the invention, the non-diamond material is carbon and the diamond/non-diamond carbon composite material is characterized by a Raman spectrum comprising at least two peaks between 1100 and 1700 cm⁻¹, more particularly one at 1332+/−15 cm⁻¹ or 1150+/−50 cm⁻¹ and one at 1560+/−30 cm⁻¹.

According to a particular embodiment of the invention the ratio of diamond peak to non-diamond peak, e.g. graphitic peak (also referred to as diamond-to graphite Raman ratio) is between 0.1 and 1000, more particularly between 10 and 100.

Thus, according to a particular embodiment of the present invention the composite or composition of diamond/non diamond material contains more than 1% non-diamond impurity, particularly at least 5% non-diamond impurity, more particularly between 5 and 50% non-diamond impurity as can be determined based on different analyses including but not limited to Raman spectrum, transmission spectroscopy, chemical analysis, and thermal conductivity measurements (which correlates with Raman data, see. P. K. Bachmann et al., 1995, Diamond and Rel. Mat. 4: 820).

The diamond/non-diamond composite material of the present invention can be obtained in different ways, known to the skilled person. According to a particular embodiment the diamond carbon composite material is obtained by a chemical vapor deposition (CVD) technique, typically using a hydrocarbon gas (e.g. methane) as a process gas in an excess of hydrogen. Chemical vapor deposition, involves a gas-phase chemical reaction occurring above a solid surface, which causes deposition onto that surface. All CVD techniques for producing diamond films require a means of activating gas-phase carbon-containing precursor molecules. This generally involves thermal (e.g. hot filament) or plasma (D.C., R.F., or microwave—also referred to as Microwave plasma assisted chemical vapor deposition or MPCVD) activation, or use of a combustion flame (oxyacetylene or plasma torches). Alternatively, methods including spin coating of diamond-carbon particles (as described by Sakaue et al., 2003, Appl. Phys. Lett. 83(11):2226-2228) can be used.

Growth rates for the various deposition processes vary considerably, and will be dependent on the ratio of sp³ (diamond) to sp²-bonded (graphite) carbon in the sample, the composition (e.g. C—C versus C—H bond content) and the crystallinity. In general, combustion methods deposit diamond at high rates (typically 100-1000 μm/hr, respectively) while the hot filament and plasma methods have much slower growth rates (0.1-10 μm/hr The diamond/non-diamond carbon composite material of the present invention has the advantage that it has a higher growth rate than phase-pure diamond and can thus be prepared at a lower cost.

The surface morphology obtained during CVD depends critically upon the gas mixing ratio and the substrate temperature. Under ‘slow’ growth conditions—low CH₄ partial pressure, low substrate temperature—a microcrystalline film is obtained, with triangular {111} facets being most evident, along with many obvious twin boundaries {100} facets, appearing both as square and rectangular forms, begin to dominate as the relative concentration of CH₄ in the precursor gas mixture, and/or the substrate temperature, is increased. Cross-sections through such microcrystalline films shows the growth to be essentially columnar. At still higher CH₄ partial pressures the crystalline morphology disappears altogether resulting in an aggregate of diamond nanocrystals and disordered graphite.

CVD diamond films can be grown on a number of different growth-substrates, the most common being single crystal silicon wafers. The main requirement is that the growth-substrate must have a melting point (at the process pressure) higher than the temperature window (600-1600 K) required for diamond growth. Suitable growth substrates include metals such as Mo, Ti, Ta, or Cu, as well as non-metals, such as silica, glass, Ge, sapphire, diamond itself, and graphite, silicon or semiconductor-containing material.

Alternatively, the diamond/non-diamond composite material or composition of the present invention can be obtained from polycrystalline diamond particles obtained under high pressure. Polycrystalline diamond/metal composites are known as PCD in the tool industry and are formed from high pressure synthetic diamond and a cobalt (or other metals) binder between grains. Explosion synthesis of diamond is performed by shooting heavy material (uranium) onto graphite targets to create a shock wave and transform graphite to diamond. The resulting fine diamond grains, often used for polishing, contain graphitic carbon and/or metallic leftovers. Such particles can be used directly or processed into bodies (e.g. by hot pressing) for use in the context of the present invention.

More particularly the composite or composition of diamond/non diamond material of the present invention is characterized in that it is conductive, i.e. it allows charge carriers to flow through it with little resistance, contrary to phase-pure material which is insulation or semi-conductive. This has the important advantage that it can be electrically contacted through the supporting structure in order to apply constant, alternating or pulsed electrical potentials to the analytes captured, immobilized or absorbed on the surface of the material of the invention. The conductivity of the material of the present invention is determined by the presence of non-diamond phase, e.g. carbon or other conductive material, present in the composite or composition.

According to the present invention, the composition or composite of diamond/non-diamond material can be used as a substrate (on a sample probe) for the presentation of a sample to an energy source, which is thereafter subjected to analysis. The use of the material is envisaged either in the form of a fixed substrate, as mixed phase particles, or in any other form. The fixed substrate can be in the form of a film, optionally as a coating deposited onto a substrate material (which can be similar, e.g. diamond or completely different from the diamond carbon composite material). Typically such a substrate or coated substrate is fixed onto a base structure or carrier, which can be of any suitable material (e.g. aluminum). The fixed substrate thus makes up (at least) the sample-presenting surface of the sample probe.

According to the present invention the diamond/non diamond composite material can be produced and/or treated to obtain different surface morphologies. Thus, diamond/non diamond carbon composite films can be obtained in a form ranging from a continuous film (no pores), over a structurally mixed product (bulk CVD diamond decorated with CVD diamond needles), to completely individualized needles that no longer form a connected network. Such oriented, needle-like CVD diamond structures allow to orient the biopolymer along the surface topology, thus enhancing capture probe activity, active surface area and efficiency. Thus, the morphology of the surface of the material can be tailored to specific applications.

Needle-like diamond can e.g. be prepared by partial oxidation of a diamond/non-diamond carbon composite as described in P. K. Bachmann et al. 1993 (Diamond and Related Materials 2: 683).

The appropriate (surface) morphology can be obtained either by using a specific production process of the diamond/non-diamond, e.g. carbon composite material or by applying particular conditions during production e.g. by vapor deposition of the diamond/non-diamond composite material. Thus, The spacing and height of the network of the needle-like units are adjustable by variables including gas mixtures used during deposition, oxidation, etching, voltage between plasma and substrate, substrate temperature, plasma power, process pressure, electromagnetic field in the vicinity of the substrate, deposition gases and flow rates, chamber conditioning, and substrate surface.

According to particular embodiment of the present invention, the morphology of the material is (at least in part) determined by the choice of the (growth) substrate used, by selecting a substrate which itself has a particular morphology. Thus, the diamond/non-diamond composite material can be deposited onto a porous surface, such as a porous silicon surface, similarly resulting in a substrate with high active surface area and efficiency. Growth of diamond films on porous silicon by MPCVD is described by Wang et al. (2000, J. Phys. Condens. Matter 12(13):L257-260). The diamond/non-diamond carbon composite film can optionally be further modified as described herein.

According to another embodiment of the present invention, the surface of the diamond/non-diamond composite material or composition is modified after deposition. Modification of the surface of the diamond/non-diamond carbon composite material or composition of the present invention can be obtained by for example ion implantation. Ion implantation breaks many sp bonds and allows their conversion to sp² type bonding, hence leading to the more conductive diamond/non-diamond carbon composite material. Other suitable techniques which may be used for the modification of the surface of diamond carbon composite material may be etching, hydrogen plasma surface treatment or a mixture of these techniques. Hydrogen plasma surface treatment has the following effects. First, the dangling bonds on the surface of diamond carbon composite can be chemically terminated by atomic hydrogen, and, generally, the C—H bonds form a dipole because of the different electronegativity. Second, as a result of the ion bombardment etching process will generate a large amount of defects and change the surface structure of diamond carbon composite material.

Methods for performing post-depositional etching of diamond, e.g. using oxidizing agents, are known to the skilled person e.g. from Bachman et al. 1993 (Diamond and related material 2:683; Hayashi et al. 2004). Etching by oxygen changes the ratio of the diamond vs. non-diamond carbon. This is reflected in the changing ratios of the diamond (1332 cm⁻¹) and G-peak (1560 cm⁻¹) in the Raman spectra. According to the present invention, care is taken during etching to ensure that material maintains a non-diamond component and does not become phase pure.

The physical structure of the composite or composition of diamond/non-diamond material, e.g. diamond/non-diamond carbon, of the present invention can be tailored for specific situations. Such modification will result in a morphology ranging from a continuous substrate, a substrate presenting a three-dimensional, columnar or needle-like surface morphology, to a substrate consisting of individual needle-like structures that no longer form a connected network, i.e. resulting in a porous structure. The enhanced three-dimensional structure is of interest for specific applications in view of the suppressed reflectance, high species adsorption, high optical absorption, analyte application control, and enhanced optical absorption.

According to a further embodiment of the present invention, the diamond/non-diamond carbon material composite or composition of the present invention is chemically modified by addition of polarities or functional groups which influence the selective adsorption and/or desorption of bioanalytes from the material. This can be done e.g. by terminating all or part of the surface with molecules including but not limited to hydrogen, oxygen, chlorine, amino groups, etc. Termination with hydrogen lowers the threshold for field- and ion-induced electron emission. Electrons emitted from the surface can more easily charge the analyte negatively and improve corresponding negative mode desorption/ionization results. A more hydrophobic surface can be produced by quenching the surface free radicals via either an addition reaction (e.g. using fluorinated olefin) or a hydrogen abstraction reaction (e.g. using alkyl amines). Starting from an H-terminated surface a molecule with a protected amine group at the end can be attached to the surface by a photochemical process, after which the amine group can be deprotected, making it reactive to a crosslinker. In a final step is an enzyme or a protein, or any other biomolecule can be attached. Oxygen termination of the CVD diamond surface is capable of suppressing electron emission from such surfaces, leading to improved ‘positive mode’ DI data.

According to a further embodiment of the present invention, the absorbance of the material of the present invention is adjusted to correspond to the wavelength used in the desorption/ionization process in which it is to be used. This can be achieved by doping the diamond/non-diamond composite material or composition with suitable dopants such as B, P, Na, Li, As, Sb or others. Beside possible other methods, in-situ doping and doping by ion implantation are suitable techniques for doping diamond. In-situ doping may be performed by adding compounds to the CVD gas phase that are then co-deposited with the growing diamond material and that act as a dopant. For instance doping with nitrogen or boron will shift the absorption of diamond (which non-doped is in the visible light range) to longer wavelengths, thus to smaller energies (Stotter et al., 2003, The Electrochemical Society USA 12(1): 33).

Besides the in-situ doping during film growth, also ion implantation allows doping of diamond. Ion implantation is a method by which energetic atoms (ions) are forced into solid targets due to their high kinetic energy. sp3 bonded carbon (diamond) is an insulator and sp² bonded carbon (graphite) is a conductor. It may be carried out by for example hot implantation and a post annealing process. The efficiency of this method of introducing electrically active centers varies strongly with the temperature of diamond during implantation and with the conditions during the subsequent annealing.

The high thermal conductivity of diamond/non-diamond carbon composite material of the present invention is an advantage for DI analysis because laser light absorbed by the surface is rapidly and uniformly distributed over an extended area and allows to desorb a larger amount of the analyte quickly and uniformly from such a surface.

According to the present invention a composite or composition of diamond/non-diamond material is used in analysis of a sample, more particularly for the detection of analytes within a sample. The sample can be organic or inorganic chemical composition, a biochemical composition, peptide, polypeptide, protein, carbohydrate, lipid, nucleic acid, cells, cellular structures, micro-organisms or mixtures thereof.

Thus, according to one embodiment of the present invention the sample is applied to the substrate comprising the diamond/non-diamond material composite or composition and then analysed by a detection means. More particularly the analysis involved discharging an energy source onto the sample, whereby the analytes in the sample are charged, (selectively) released from the substrate and typically entered into a vacuum having an electric field which induce a movement through or towards a detection device.

The ionized/gaseous form of the sample can be obtained using different techniques ranging from evaporation to ion beam bombardment, depending on the sample. In addition to lasers, all kinds of light sources can thus be used, e.g. high power LEDs (braod-band or with specific colors), discharge lamps (with photographic flash lights one can ignite CNTs to burn in oxygen); Alternative energy sources include non-photonic energy sources such as electrical currents, e-beams, ion beams etc.

According to a particular embodiment the material of the present invention is used as a substrate for laser desorption mass spectroscopy.

The sample can be applied to the substrate comprising a composite or composition of diamond/non-diamond carbon material by a variety of different means, including but not limited to adsorption from a solid, liquid or gas or by direct application to the surface of the substrate as a solid or liquid. Optionally, the sample can be applied to the directly from a chemical separation means including liquid chromatography, gas chromatography, and deposited thin-film chromatography.

The detection device used in the analysis of samples within the context of the present invention includes mass spectroscopy, more particularly using time of flight (TOF) analysis for species identification. Alternatively, other methods of detection can be envisaged within the context of the invention including detection methods based on antigen-antibody reaction, fluorescence detection means, optical detection means, radioactivity detection means, electrical detection means, chemical detection means, antigen-antibody reaction detection and combinations thereof.

Optionally, according to the present invention, the diamond/non-diamond composite or composition substrate is modified or functionalized in a physical and/or chemical way as described above so as to allow selective adherence and/or release of analytes in a sample. Chemical functionalization can be achieved by molecules including reactive, non-reactive, organic, organo-metallic and non-organic species. More particularly, chemical modification can comprise steps such as oxidation, reduction, addition of chemical groups (e.g. Cl).

In another embodiment of the invention, the film is modified to adhere an antibody, antibodies or other chemical moiety, which react with components within the sample. A detection means is then used to detect antigen-antibody reaction or the adherence of the antibody, antibodies or other chemical to the film. In a further embodiment of the invention, the film is modified to adhere cells including neuronal, glia, osteoblasts, osteoclasts, chondrocytes, kerotinocytes, melanocytes, and epidermal cells; whereby the cells proliferate on the film. In a further embodiment of the invention, the film is modified to adhere cells including neuronal, glia, osteoblasts, osteoclasts, chondrocytes, kerotinocytes, melanocytes, and epidermal cells; whereby the cells proliferate on the film. The film can be modified so that cell proliferation is controlled or restricted. Also, the film with cells adhered can be placed in vivo.

Optionally, the diamond/non-diamond material composite or composition can be used as a substrate for a sample on which a particular reaction is to be performed. According to this embodiment of the invention, the substrate can be functionalized to ensure specific adherence and/or orientation of one or more molecules in the sample, after which the substrate and the molecules adhered thereto are contacted with a reagent and the interaction between the molecule and said reagent is detected (including high-throughput reactions involving nucleic acids or proteins).

According to a further embodiment of the present invention, the diamond/non-diamond material composite or composition can be used as a substrate for a library of samples to be screened for the presence of particular properties, whereby the analysis can be done by a detection means. The matrix of the present invention is particularly attractive for integration into high-throughput sample analysis systems (i.e., large-scale proteomics).

According to a further embodiment the diamond carbon composite material is used to producing contacts to organic semiconductors and molecules used in molecular electronics.

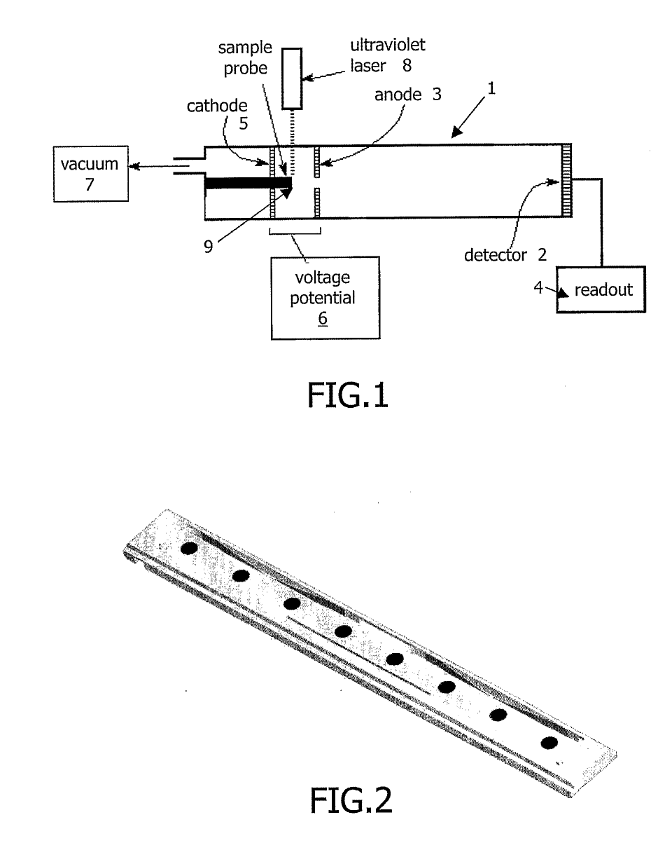

FIG. 1 Schematic representation of a desorption-ionization mass spectrometry (DI-MS) apparatus.

FIG. 2 Schematic representation of a carrier according to a particular embodiment of the invention for use in SELDI-MS.

### DESORPTION-IONIZATION APPARATUS

FIG. 1 shows a schematic representation of a desorption-ionization apparatus, such as a DI-MS, e.g. a MALDI apparatus or for example a SELDI apparatus, with which the present invention may be used. It comprises a hollow chamber 1 with a probe sample 9 located in the chamber. The chamber is held under vacuum by a vacuum pump 7. A source of energy 8 is arranged and so directed that analytes on the probe sample 9 can be ionised. For example, the source of energy can be a laser, e.g. an ultraviolet laser. The ionised analytes are drawn away from the probe sample by an electric and/or magnetic field generated by a field generator 6. For example, an electric potential may be applied between two electrodes 3, 5 in a series arrangement. The accelerated ionised analytes are then detected at a detector 2 having read out electronics 4. The detector may be placed at a certain distance from the probe sample and the read out electronics may be used for Time-of-Flight determinations of the ionised analytes.

Any of the composites or compositions of diamond/non-diamond material of the present invention can be used as a substrate on a sample probe for a desorption-ionization apparatus such as shown in FIG. 1. Any of the composites or compositions of diamond/non-diamond material of the present invention can be used for coating the substrate on the sample probe or as matrix material in a conventional DI-MS, e.g. MALDI apparatus, or for example a SELDI apparatus.

Desorption-Ionization Device

FIG. 2 shows a carrier in accordance with an embodiment of the present invention for use in desorption-ionization apparatus. The carrier comprises an aluminium holder with a silicon strip clamped onto its surface. Diamond/non-diamond composite material is grown onto the silicon in the form of 2 mm diameter regions (black spots) by selectively pretreating the respective area (dot) with e.g. diamond particles to foster nucleation.

Light (Laser) Desorption-Ionization

Samples are analyzed using a ABI Qstart mass spectrometer equipped with a SELDI port and using 337 nm light from a nitrogen laser. Substrates are attached to the face of the conventional MALDI target the holder shown in FIG. 2. Analysis is performed in linear mode with instrument parameters identical to normal MALDI operation except no low-mass cut-off was employed.

Mass Spectra Stored in a Memory Device

Mass spectrometric patterns generated using the diamond carbon composition or composite material of the present invention using apparatus and devices described above are characterized by the presence of characteristic diamond/non-diamond material peaks (when the material of the invention is used as a conventional matrix) or can be characterized by a specific profile due to the interaction between analyte and the diamond/non-diamond composite or composition substrate material of the present invention. A further aspect of this invention thus relates to a data structure comprising the patterns obtained using the substrates of the present invention stored in a memory device, e.g. a diskette, a solid state storage device such as a memory of a computer or a memory of a network device, an optical storage device such as a CD-ROM or a DVD-ROM, or a tape storage device.

It is to be understood that although preferred embodiments, specific constructions and configurations, as well as materials, have been discussed herein for devices according to the present invention, various changes or modifications in form and detail may be made without departing from the scope and spirit of this invention.

1. The use of a composite or composition of diamond/non-diamond material in a method for desorption/ionization analytics.

2. The use of claim 1, wherein said non-diamond material is a conductive material

3. The use of claim 1 wherein said non-diamond material is non-diamond carbon.

4. The use of claim 1, wherein said composite or composition of diamond/non-diamond material is modified or functionalized in a physical and/or chemical way.

5. The use of claim 1, wherein said composite or composition of diamond/non-diamond material has a three-dimensional structure.

6. The use of claim 1, wherein said composite or composition of diamond/non-diamond material is porous.

7. The use of claim 1, wherein said composite or composition of diamond/non-diamond material is chemically modified by oxygenation or hydrogenation.

8. The use of claim 1, wherein said composite or composition of diamond/non-diamond material is used as a fixed substrate.

9. The use of claim 1, wherein said composite or composition of diamond/non-diamond material is wherein said method is used in the form of a particle solution.

10. The use of claim 1, wherein said method is mass spectrometry analysis.

11. The use of claim 1, wherein the chemical composition of said composite or composition of diamond/non-diamond material is adapted to ensure absorption at the wavelength of the light source used for ionization/desorption.

12. The use of claim 1, wherein said composite or composition of diamond/non-diamond material is obtained by chemical vapor deposition on a growth-substrate.

13. The use of claim 12, wherein said growth-substrate is selected from metals, non-metals, such as glass, Ge, sapphire, diamond itself, and graphite, silicon or semiconductor-containing material or mixtures thereof

14. A method for the analysis of a sample comprising the steps of: (a) applying a sample to a substrate comprising a composite or composition of diamond/non-diamond material; and (b) analyzing said sample by a detection means.

15. The method of claim 14, wherein said non-diamond material is a conductive material.

16. The method of claim 14, wherein said non-diamond material is non-diamond carbon.

17. The method according to claim 14, wherein said sample is selected from the group consisting of: organic chemical compositions, inorganic chemical compositions, biochemical compositions, cells, micro-organisms, peptides, polypeptides, proteins, lipids, carbohydrates, nucleic acids, or mixtures thereof.

18. The method according to claim 14, wherein said composite or composition of diamond/non-diamond material has a three-dimensional structure.

19. Apparatus for desorption/ionization analytics, comprising:
a substrate provided with a composite or composition of diamond/non-diamond material,
a source of energy for directing energy onto the substrate, and
a detection means for analyzing substances emitted from said substrate.

20. The apparatus of claim 19, wherein said non-diamond material is a conductive material.

21. The apparatus of claim 19, wherein said non-diamond material is non-diamond carbon.

22. The apparatus of claim 19, wherein said composite or composition of diamond/non-diamond material is modified or functionalized in a physical and/or chemical way.

23. The apparatus of claim 19, wherein said composite or composition of diamond/non-diamond material has a three-dimensional structure.

24. The apparatus of claim 19, wherein said composite or composition of diamond/non-diamond material is porous.

25. The apparatus of claim 19, wherein said composite or composition of diamond/non-diamond material is chemically modified by oxygenation or hydrogenation.

26. A substrate adapted for use in an apparatus for mass spectrometry characterized in that it comprises a composite or composition of diamond/non-diamond material.

27. The substrate of claim 26, wherein said non-diamond material is a conductive material.

28. The substrate of claim 26, wherein said non-diamond material is non-diamond carbon.

29. The substrate of claim 26, wherein said substrate comprises a coating of a composite or composition of diamond/non-diamond material.

30. The substrate of claim 29, wherein said composite or composition of diamond/non-diamond material is coated onto silicon or glass.
